(19) United States
(12) Patent Application Publication
(10) Pub. No.: US 2002/0161598 A1
(43) Pub. Date: Oct. 31, 2002

(54) Integrated goods and online service vending machine

(75) Inventor: Nam Joong Kim, Taegu City (KR)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: C&HI Co., Ltd. And Insis Co., Ltd.

(21) Appl. No.: 09/916,707

(22) Filed: Jul. 27, 2001

(30) Foreign Application Priority Data
Apr. 26, 2001 (KR) 2001-22748

(51) Int. Cl. G06F 17/60

(52) U.S. Cl. 705/1; 705/17; 705/14; 235/381

(57) ABSTRACT

An integrated goods and online services vending machine includes an indication module for displaying items and services list and receiving a request by a customer's selection, an advertisement module for displaying various advertisements, a card settlement unit for identifying customer's card and charging the card on requesting, and an electronic control unit (ECU) for integrally controlling the indication module, the advertisement module, and the card settlement unit 130, wherein the ECU requests settlement permission from an authentication organization via public network on the basis of information from the card settlement unit and executes the service request inputted through the indication module if the authentication organization permits a present settlement.

### BACKGROUND OF THE INVENTION

(a) Field of the Invention

The present invention relates to a vending machine, and in particular, to an integrated goods and online services vending machine capable of providing interactive online services and allowing an operator to remotely monitor raw sales data as well as dispensing goods stocked in the vending machine.

(b) Description of the Related Art

Vending machines are well known devices through which various goods or services such as Internet access are retailed. The vending machines are actuated by coins and/or bills and then the items they provide are activated by means of buttons so as to be selected.

Typically, the vending machines are used to expand the sales of goods by providing customers with the convenience of self-service and twenty four-hour access without substantial labor costs.

However, the profit of the conventional vending machine are limited to the sales of commercial goods and services.

Also, the conventional vending machines are not utilized as advertisement facilities for maximum profit thereof.

Furthermore, the conventional vending machine has several drawbacks, in comparison with traditional retail merchandising, particularly relating to the sales monitoring, inventory management, and price decision.

### SUMMARY OF THE INVENTION

The present invention has been made in an effort to solve the above problems of the prior art.

It is an object of the present invention to provide a vending machine capable of integrating an advertising function and online banking and contents services through a public network such as the Internet as well as sales of goods.

It is another object of the present invention to provide a vending machine that allows operators to remotely monitor and manage inventory, operation state, kinds and prices of items, and etc.

To achieve the above object, the integrated goods and online services vending machine of the present invention comprises an indication module for displaying items and services list and receiving a request by a customer's selection, an advertisement module for displaying various advertisements, a card settlement unit for identifying customer's card and charging the card on requesting, and an electronic control unit (ECU) for integrally controlling the indication module, the advertisement module, and the card settlement unit 130, wherein the ECU requests settlement permission from an authentication organization via public network on the basis of information from the card settlement unit and executes the service request inputted through the indication module if the authentication organization permits a present settlement.

### BRIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1 is a block diagram illustrating an integrated goods and online service vending machine according to the preferred embodiment of the present invention;

FIG. 2 is a perspective view illustrating advertisement module of the integrated goods and online service vending machine of FIG. 1; and

FIG. 3 is a front view of the vending machine of FIG. 1 implemented according to the preferred embodiment of the present invention.

### DETAILED DESCRIPTION OF THE PREFERRED EMBODIMENTS

A preferred embodiment of the present invention will be described hereinafter with reference to the accompanying drawings.

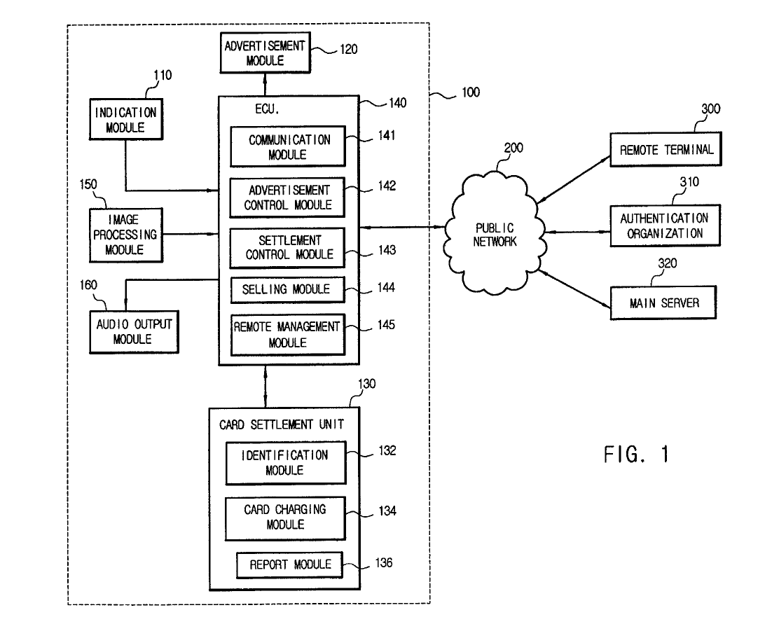

FIG. 1 is a block diagram illustrating an integrated goods and online service vending machine according to the preferred embodiment of the present invention.

As shown in FIG. 1, the integrated goods and online service vending machine 100 of the present invention comprises an indication module 110 for displaying items and services list and a receiving customer's selection input; an advertisement module 120 for displaying various advertisements; a card settlement unit 130 for identifying customer's card and charging the card as much as requested; and an electronic control unit (ECU) 140 for integrally controlling the indication module 110, the advertisement module 120, and the card settlement unit 130. The ECU requests settlement permission from an authentication organization via public network on the basis of information from the card settlement unit and executes the service request inputted through the indication module if the authentication organization permits a present settlement.

The indication module 110 has an image display (now shown) for guiding the customer to select items or services and a touch screen (not shown) for receiving the customer's selection.

It is preferred that the image display is a Thin Film Transistor-Liquid Crystal Display (TFT-LCD).

The touch screen is provided with a touch screen controller (not shown) and a touch screen sensor (not shown) applied over the image display for detecting the customer's selection. The touch screen sensor detects the customer's selection and correspondingly generates a selection signal and sends the same to the ECU 140.

The card settlement unit 130 comprises an identification module 132 for identifying a proposed card and reading information stored in the card, a card charger 134 for charging the card with money as much as the customer requests, and a report module 136 for outputting a transaction report.

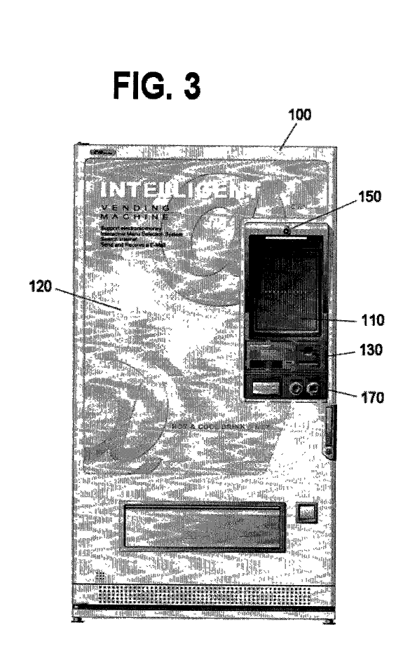

A payment can be carried out by cash or credit card such that the ECU 140 determines if the present transaction is carried out by the cash or credit card by sensing a cash inlet/outlet module 170 (see FIG. 3) and the card identification module 132.

If the present transaction is carried out by the credit card, the ECU 140 request payment permission from an authentication organization through a public network such as Internet and then provides a service selected by the customer if the transaction is permitted.

It is preferred that the card identification module 132 uses a Secure Application Module (SAM) which is able to identify magnetic stripe credit card, debit card, cash card, smart card (IC, RF, COBI IC, etc.) of all the banks so as to securely read the data in the cards. Also, the security can be achieved by encrypting data using a private and public key data encryption algorithm.

The integrated goods and online service vending machine 100 further comprises an image processing module 150 for processing multimedia e-mail and monitoring images and the cash inlet/outlet module 170 for receiving coins and bills and returning changes (see FIG. 3).

Also, the integrated goods and online service vending machine 100 further comprises an audio output module 160 for outputting sounds according to a control signal from the ECU 140, and a document printing module (not shown) for printing out civil affair document and supporting the internet business and online reservation services under control of the ECU 140.

The integrated goods and online service vending machine 100 further comprises an wireless communication module (not shown) for supporting local wireless communication such as Bluetooth and Infrared Data Association (IrDA) communication so as to enable the customer to access to the Internet using a notebook computer or a personal digital assistant (PDA) equipped with the same communication module.

The advertisement module 120 can be a rotary advertiser or a digital display such as a plasma display panel (PDP) and light-emitting diode (LED) display board. In case of digital display, the ECU 140 can be remotely controlled at an operator's terminal through the Internet so as to display various multimedia advertisements on the advertisement module 120 and the indication module 110.

The ECU 140 comprises a communication module 141 for controlling the online communication and local wireless communication, an advertisement control module 142 for changing the advertisement in a predetermined time interval, a settlement control module 143 for identifying the credit card and for requesting settlement permission from the authentication organization 310 through the Internet or appreciating the amount of money deposit in the cash inlet/outlet module 170 so as to provide the service required by the customer, a selling module 144 for dispensing the goods ordered by the customer according to a signal from the settlement control module 143, and a remote management module 145 for transmitting information such as the inventory, sales status, and system status in response to a request from the remote terminal 300 through the Internet.

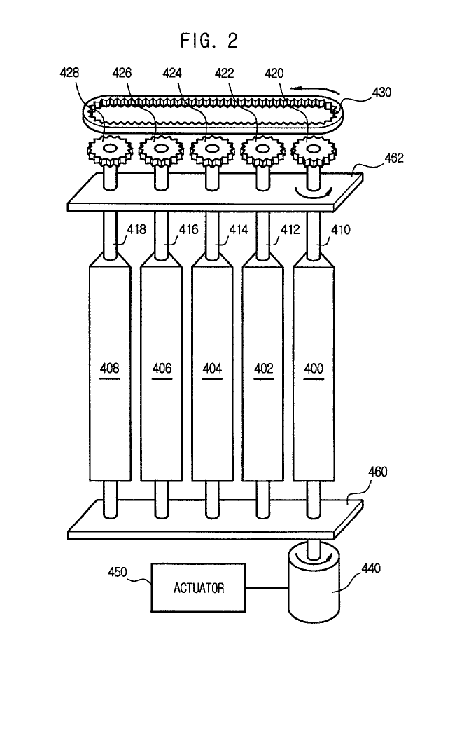

FIG. 2 is a perspective view illustrating a rotary advertiser as one example of display of the integrated goods and online service vending machine of the present invention.

Referring to FIG. 2, the advertisement module 120 comprises a plurality of rotary advertisement boards 400, 402, 404, 406, and 408 each having a shape of triangular prism; a plurality of rotary shafts 410, 412, 414, 416, and 418 penetrating corresponding rotary advertisement boards 400, 402, 404, 406, and 408 and fixed therein; a pair of support plates 460 and 462 each arranged in upper and lower portion of the rotary shafts 410, 412, 414, 416, and 418 for rotationally supporting the rotary shafts 410, 412, 414, 416, and 418; a plurality of gears 420, 422, 424, 426, and 428 correspondingly fixed to upper ends of the rotary shafts 410, 412, 414, 416, and 418; a driving belt 430 engaged with all the gears 420, 422, 424, 426, and 428; a motor 440 connected to a lower end of one of the rotary shafts 410, 412, 414, 416, and 418 for rotating the rotary shaft, and an actuator 450 electrically connected to the motor 440 for actuating the motor according to a signal from the ECU 140.

The rotary displayer has a plurality of the advertisement boards each having three advertisement surfaces such that a plurality of different advertisements as much as the number of the advertisement surfaces can be displayed. Also, each advertisement board can be set to rotate in a predetermined time interval such that the different advertisements can be periodically displayed.

FIG. 3 is a front view of the vending machine implemented according to the preferred embodiment of the present invention.

In FIG. 3, the advertisement module 120 of the present invention is implemented using the PDP or LED display board.

The operation of the integrated goods and online service vending machine will be described with reference to FIG. 1˜FIG. 3 hereinafter.

Once cash (a coin or bill) is inserted into the cash inlet/outlet module 170, the cash inlet/outlet module 170 appreciate the cash and sends the data to the settlement control module 143 of the ECU 140.

In case when a credit card is inserted into the card settlement unit 130, the identification module 132 of the card settlement unit 130 extracts information needed for identifying and requesting the settlement permission. If the card is identified, the settlement module 143 of the ECU 140 requests the settlement permission from the authentication organization 310 through the public network 200.

The authentication organization 310 analyses the card information from the integrated goods and online service vending machine responsively sends a permission signal to the integrated goods and online service vending machine 100 if the information is valid.

If the vending machine receives the permission signal form the authentication organization 310, the ECU 140 activates the indication module 110 so as to allow the customer to select an item among the goods, online banking services, and internet access.

If an item is selected by touching the touch screen, the selling module of the ECU 140 dispenses the selected item and outputs a transaction report through the report module 36 of the card settlement unit 130 if the settlement is carried out by the card.

If the online banking service is selected, the integrated goods and online service vending machine 100 access the authentication organization 310 via the public network so as to confirm customer account valance and provides the online banking service such as electronic fund transfer, credit inquiry, prepaid money checking and card charging, bonus point checking, and etc.

If the pre-paid card charging service is selected, the settlement module 143 of the ECU 140 controls the card charging module 134 so as to charge the card with as much as the requested amounted on the basis of a permission signal from the authentication organization 310.

Also the integrated goods and online service vending machine 100 provides the online services such as the electronic business, web search, reservation, email, civil affair document printing, and etc.

When using the multimedia email, a customer's photograph is taken by the image processing module 150 and message is inputted through the touch screen such that the image and text are sent to a mail server 320 through the public network 200.

Also, the image processing module 150 monitors surroundings of the integrated goods and service vending machine 100 and sends the image to the remote operator's terminal 300 for preventing the integrated goods and service vending machine 100 from being robbed and broken.

If the civil affair document printing service is selected through the touch screen, the integrated goods and service vending machine 100 accesses to a government office server (not shown) and sets the touch screen with available document list. Consequently, if a document is selected, the document is outputted through the report module 136 of the card settlement unit 130 after payment is executed by the settlement control module 143.

The advertisement module 120 can be implemented using one of the rotary advertiser of FIG. 2 and the PDP or LED display board of FIG. 3.

In case of the rotary advertiser, the actuator 450 previously actuates the motor 440 during a predetermined period according to the signal from the ECU 140. The ECU 140 controls the actuator 450 according to a rotary advertiser control algorithm saved in a storage (not shown). The motor 440 rotates the rotary shaft 410 such that all the rotary shafts 410, 412, 414, 416, and 418 engaged by means of the belt 430 are driven at the same time. Accordingly, the rotary advertisement boards 400, 402, 404, 406, and 408 mounted on the rotary shafts 410, 412, 414, 416, and 418 rotate such that the different advertisements are periodically displayed.

On the other hand, in case the advertisement module 120 is equipped with the PDP or LED display board, the ECU 140 controls the advertisement module 120 to display multimedia advertisements from the remote operator terminal in real time and controls the audio report module 160 to output audio sounds.

The advertisement module 120 is not limited by the above-mentioned display devices but can be implemented using various modified devices such as continuously rotating board using a plurality of rollers.

Also, the advertisements from the remote administration terminal can be stored in the storage and then be periodically displayed under control of the ECU 140 even in off-line state.

To maximize advertisement effect, the advertisements from the remote administration terminal 300 can be displayed on an image output part (not shown) of the indication module 110 as well as on the advertisement module 120 under control of the ECU 140.

The remote management module 145 of the ECU 140 transmits information on the inventory, sales data, and operation status to the remote operator's terminal 300 in response to a terminal request.

Also, the ECU 140 can be implemented by installing a main board provided with a central processing unit (CPU), a random access memory (RAM), a read only memory (ROM), a hard disc, a graphic card, a sound card, and a local area network (LAN) card.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the integrated goods and online service vending machine of the present invention is provided with the advertisement module which is implemented by a rotary advertiser and/or digital display such as PDP and LED display boards such that it is possible to maximize the total profits of the vending machine through the advertisement service as well as the sales of goods.

Also, the integrated goods and online service vending machine of the present invention diversifies the profit sources by providing pay internet access and online financial services as well as goods sale such that the profits can be maximized.

Furthermore, since the integrated goods and online service vending machine of the present invention provides remote monitor and management functions, the operator can remotely monitor the inventory, operation state of the vending machine, kinds of items, and etc. and remotely set prices of the items, resulting in minimizing the whole management costs.

What is claimed is:

1. An integrated goods and online services vending machine comprising;
an indication module for displaying items and services list and receiving a request by a customer's selection;
an advertisement module for displaying various advertisements;
a card settlement unit for identifying customer's card and charging the card as much as the customer requests; and
an electronic control unit (ECU) for integrally controlling the indication module, the advertisement module, and the card settlement unit 130,
wherein the ECU requests settlement permission from an authentication organization via public network on the basis of information from the card settlement unit and executes the service request inputted through the indication module if the authentication organization permits a present settlement.

2. The integrated goods and online service vending machine of claim 1 wherein the indication module comprises:
an image display for displaying menus of items, banking services, and internet services; and
a touch screen for receiving a request by the customer selection.

3. The integrated goods and online service vending machine of claim 1 wherein the card settlement unit comprises:
an identification module for identifying a proposed card and reading information stored in the card; a card charger for charging the card with as much as the customer requests; and
a report module for outputting a transaction report.

4. The integrated goods and online service vending machine of claim 1 further comprises an image processing module 150 for processing multimedia e-mail and monitoring surroundings of the vending machine.

5. The integrated goods and online service vending machine of claim 1 further comprises a cash inlet/outlet module for receiving coins and bills and returning changes.

6. The integrated goods and online service vending machine of claim 1 wherein the ECU supports electronic business and reservation service using the public network.

7. The integrated goods and online service vending machine of claim 1 further comprises a document printing module for printing civil affair documents under control of the ECU.

8. The integrated goods and online service vending machine of claim 1 further comprises an audio output module 160 for outputting sounds according to a control signal from the ECU.

9. The integrated goods and online service vending machine of claim 1 further comprises a wireless communication module for supporting local wireless communication.

10. The integrated goods and online service vending machine of claim 9 wherein the wireless communication module uses Bluetooth standard.

11. The integrated goods and online service vending machine of claim 9 wherein the wireless communication module uses Infrared Data Association (IrDA) standard.

12. The integrated goods and online service vending machine of claim 1 wherein the advertisement module comprises:
at least one or more advertisement board(s) each having a shape of polygonal column;
at least one or more rotary shaft penetrating corresponding advertisement boars in longitudinal direction and fixed therein;
a pair of support plates each arranged in upper and lower portion of the rotary shafts for rotationally supporting the rotary shafts;
gears correspondingly mounted at upper ends of the rotary shafts;
a driving belt engaged with the gears for transferring driving force to the gears;
a motor connected to a lower end of one of the rotary shafts for rotating the rotary shafts; and
an actuator electrically connected to the motor for actuating the motor according to a control signal from the ECU.

13. The integrated goods and online service vending machine of claim 1 wherein the advertisement module is a Plasma Display Panel (PDA) or a Light Emitting Diode (LED) display board.

14. The integrated goods and online service vending machine of claim 1 wherein the ECU comprises:
a communication module for controlling the online communication and local wireless communication;
an advertisement control module for changing the advertisement in a predetermined time interval;
a settlement control module for identifying the credit card and for requesting settlement permission from the authentication organization through the public network or appreciating amount of money deposit in the cash inlet/outlet module so as to provide services requested by the customer; and
a selling module for dispensing goods according to a signal from the settlement control module.

15. The integrated goods and online service vending machine of claim 13 wherein the ECU comprises:
a communication module for controlling the online communication and local wireless communication;
an advertisement control module for changing the advertisement in a predetermined time interval;
a settlement control module for identifying the credit card and for requesting settlement permission from the authentication organization through the public network or appreciating amount of money deposit in the cash inlet/outlet module so as to provide services requested by the customer; and
a selling module for dispensing goods according to a signal from the settlement control module.

16. The integrated goods and online service vending machine of claim 14 wherein the multimedia advertisements from a remote terminal through the public network are displayed on the indication module and the advertisement module under control of the ECU.

17. The integrated goods and online service vending machine of claim 14 wherein the ECU further comprises a remote management module 145 for transmits information on inventory, sales data, and operation status of the vending machine to the remote operator's terminal in response to a terminal request.
